(19) United States
(12) Patent Application Publication
(10) Pub. No.: US 2024/0313556 A1
(43) Pub. Date: Sep. 19, 2024

(54) PORTABLE CHARGING CASE

(71) Applicant: GSW Creative Corp., Santa Monica, CA (US)

(72) Inventor: Thomas FORNARELLI, Chicago, IL (US)

(73) Assignee: GSW Creative Corp., Santa Monica, CA (US)

(21) Appl. No.: 18/395,885

(22) Filed: Dec. 26, 2023

Related U.S. Application Data
(63) Continuation of application No. 17/201,656, filed on Mar. 15, 2021, now abandoned.
Application No. 17/201,656 is a continuation of application No. PCT/US2018/054409, filed on Oct. 4, 2018.

(51) Int. Cl. H02J 7/00; A24F 40/53; A24F 40/95

(52) U.S. Cl. CPC H02J 7/0044; A24F 40/53; A24F 40/95; H02J 7/0048; H02J 2207/30

(57) ABSTRACT

A portable charging case comprises an internal rechargeable power supply. A first housing is sized to receive a battery portion attached to a first reservoir portion of a vaporization pen, where a first sensor disposed within the first housing makes contact with and determines the charge level of the battery portion. A second housing is sized to receive a second reservoir portion of a vaporization pen. Circuitry is in operational contact with the power supply and the first sensor.

### CROSS-REFERENCE TO RELATED APPLICATIONS

This application is Continuation of U.S. patent application Ser. No. 17/201,656, filed Mar. 15, 2021 and titled “Portable Charging Case,” which is a bypass Continuation of International Application No. PCT/US2018/054409, filed Oct. 4, 2018 and titled “PORTABLE CHARGING CASE,” the entire contents of each of which are expressly incorporated by reference herein for all purposes.

### FIELD OF THE INVENTION

The present invention relates to a charging case for a vaporization device. More specifically, the present invention relates to a portable charging case for use with a vaporization pen.

### BACKGROUND

Vaporization devices can include one or more vaporization pens. A vaporization pen typically includes at least a heating element, a vaporization chamber, a battery, and a reservoir. The reservoir is filled with electronic liquid (e-liquid) which can be composed of essential oils and other chemicals such as nicotine, herbs, and/or cannabinoids. A wick acts as a bridge between the e-liquid in the reservoir and the vaporization chamber. The vaporizer pen works by heating up the e-liquid to a specific temperature then releasing its active substance/essential oils in the form of vapor. A sensor, for instance, but not limited to, an air sensor or pressure sensor, in communication with a printed circuit board (PCB) and the battery, activates the heating element that creates vapor from the e-liquid in the vaporization chamber.′

Power for the heating element for vaporizing the e-liquid is supplied by the battery operatively connected to the heating element within the pen. The battery can be a disposable single use battery or more preferably a rechargeable battery that can be charged, for example, using a wall adapter having any of a variety of power interface plugs, for example without limitation, a USB interface plug or a micro-USB interface plug. Alternatively, the battery of a vaporizer pen can be charged using a portable charging case.

Users of vaporization pens often have a need or desire to keep track of the type and amount of e-liquids that they consume. This need may be a medical need, for example, to keep track of the amount of e-liquids consumed that have a medicinal value to the user when consumed within prescribed limits. The user may alternatively just want to know how much of a particular variety of e-liquid they are consuming. It would be very useful if the portable charging case had the ability to sense the type and level of e-liquid within the reservoir of a pen. It would further be useful if this type and level data could be stored within the portable charging case or transferred from the portable charging case to another electronic device for analysis and review of the data. There exists a need for a portable charging case for a vaporization pen that not only charges the batteries that power the pen but that can also track the usage of e-liquid by type and volume.

### SUMMARY OF THE INVENTION

According to one aspect of the invention, a portable charging case comprises an internal rechargeable power supply. A first housing is sized to receive a battery portion attached to a first reservoir portion of a vaporization pen. A first sensor disposed within the first housing makes contact with and determines the charge level of the battery portion. A second housing is sized to receive a second reservoir portion of a vaporization pen. Circuitry is in operational contact with the power supply and the first sensor.

According to another aspect of the invention, a portable charging case comprises an internal rechargeable power supply and a first housing sized to receive a battery portion attached to a first reservoir portion of a vaporization pen. A second housing is sized to receive a second reservoir portion of a vaporization pen. A first sensor is disposed in the first housing to sense the type and level of e-liquid disposed within the first reservoir portion, and a second sensor is disposed within the second housing to sense the type and level of e-liquid disposed within the second reservoir portion. The first and second sensors are operationally connected to the internal rechargeable power supply and to circuitry internal to the charging case.

According to a further aspect of the invention, a portable charging case comprises an internal rechargeable power supply and a first housing sized to receive a battery portion attached to a first reservoir portion of a vaporization pen. A first sensor is disposed within the first housing, where the first sensor makes contact with the battery portion disposed within the first housing and determines the charge level of the battery portion. A second sensor is disposed within the first housing to sense the type and level of e-liquid disposed within the first reservoir portion. A second housing is sized to receive a second reservoir portion of a vaporization pen. A third sensor disposed within the second housing senses the type and level of e-liquid disposed within the second reservoir portion.

### BRIEF DESCRIPTION OF THE DRAWINGS

FIG. 1 is a perspective view of an embodiment of a charging case for a vaporization pen;

FIG. 2 is a first side view of the charging case of FIG. 1;

FIG. 3 is a second side view of the charging case of FIG. 1;

FIG. 4 is a cross-sectional view of the charging case of FIG. 1 taken along the lines 4-4 of FIG. 2.

FIG. 5 is a cross-sectional view of the charging case of FIG. 1 taken along the lines 5-5 of FIG. 2.

FIG. 6 is an edge view of the charging case of FIG. 1;

FIG. 7 is a top view of the charging case of FIG. 1 illustrating the closure in a closed position.

FIG. 8 is a top view of the charging case of FIG. 1 illustrating the closure in a partially open position.

FIG. 9 is a top view of the charging case of FIG. 1 illustrating the closure in an open position; and

FIG. 10 is a first side view of the charging case of FIG. 1 illustrating the closure in a raised position.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

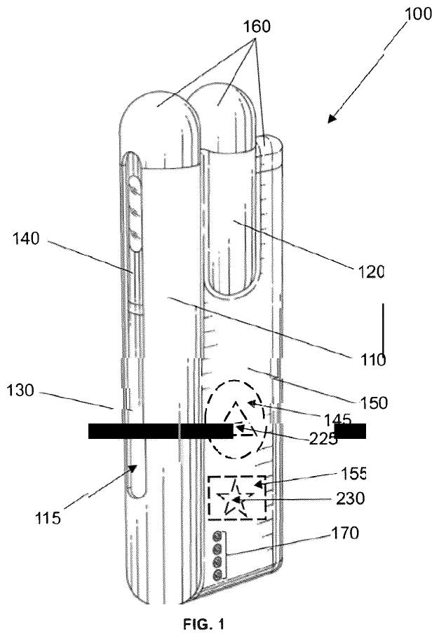

Referring to FIG. 1, an embodiment of a charging case 100 includes a first housing 110 and a second housing 120. An opening 115 disposed through a wall of the first housing 110 allows visual access to the contents of the first housing 110. Taking advantage of this visual access as shown in FIG. 1, the first housing 110 is sized to receive a battery portion (visible through the opening 115 at 130) attached to a reservoir portion (visible through the opening 115 at 140) of a vaporization pen. The second housing 120 is sized to receive a reservoir portion 140 of a vaporization pen. The charging case 100 can be made from any suitable rigid materials, for example including without limitation, metals and plastics. In one embodiment the preferred material is medical grade plastic.

An internal rechargeable power supply 145 (illustrated schematically as a dashed ellipse in FIG. 1) is disposed within a body 150 of the charging case 100. Multifunctional circuitry 155 (illustrated schematically as a dashed rectangle in FIG. 1) also disposed within the body 150 is operationally connected with the power supply 145 and with electrical contacts 210 and sensors 190, 210 (described below) disposed within the first and second housings 110, 120. In a basic embodiment, the circuitry 155 is configured to deliver power from the power supply 145 to the electrical contacts 210 (see FIG. 5) to charge the battery portion 130 disposed within the first housing 110.

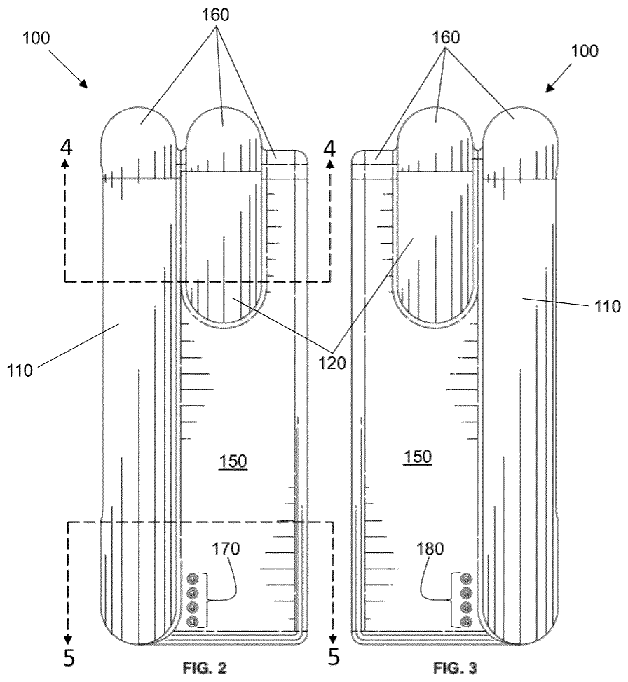

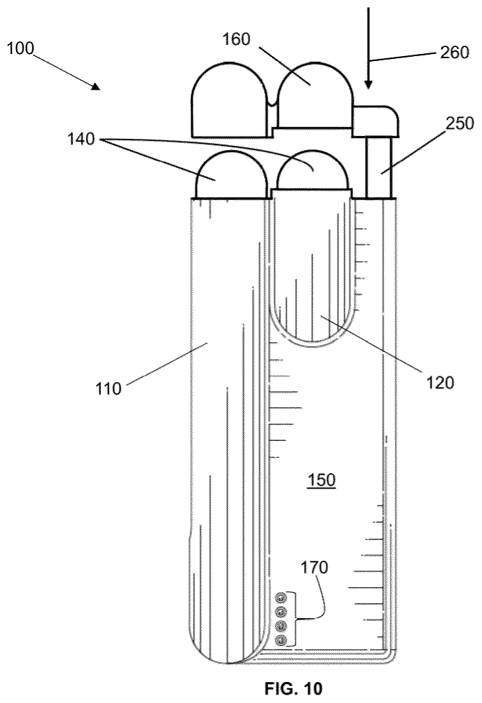

Referring to FIGS. 2 and 3, two opposite sides of the charging case 100 are shown. A closure 160 is mounted to an end of the charging case 100 to cover open ends of the first and second housings 110, 120 in a closed position as shown in FIGS. 1-3. The closure 160 can be disposed in a partially open position (see FIG. 8) where an open end of the first housing 110 is uncovered by the closure 160, and an open position (see FIG. 9) where open ends of the first and second housings 110, 120 are uncovered by the closure 160. The positions and operation of the closure 160 are described in further detail below.

Still referring to FIGS. 2 and 3, in one embodiment indicator lights 170, 180 visible on surfaces of the body 150 are also controlled by the circuitry 155 to provide a user a visual indication of the state and/or activity of the charging case 100. For example, in one embodiment, one or both sets of indicator lights 170, 180 illuminate in a first predetermined pattern of illumination that indicates the charge level of the battery portion 130 disposed inside the first housing 110. For example, in another embodiment, one or both sets of indicator lights 170, 180 illuminate in a second predetermined pattern that indicates that power is being delivered from the power supply 145 to charge the battery portion 130 disposed inside the first housing 110. The predetermined patterns of illumination may comprise, for example, any combination of particular colors of illumination of each light, flashing of the lights in a particular sequence and/or at a particular frequency, or solid illumination of one or more of the lights. The multifunctional circuitry 155 has additional functions as described below.

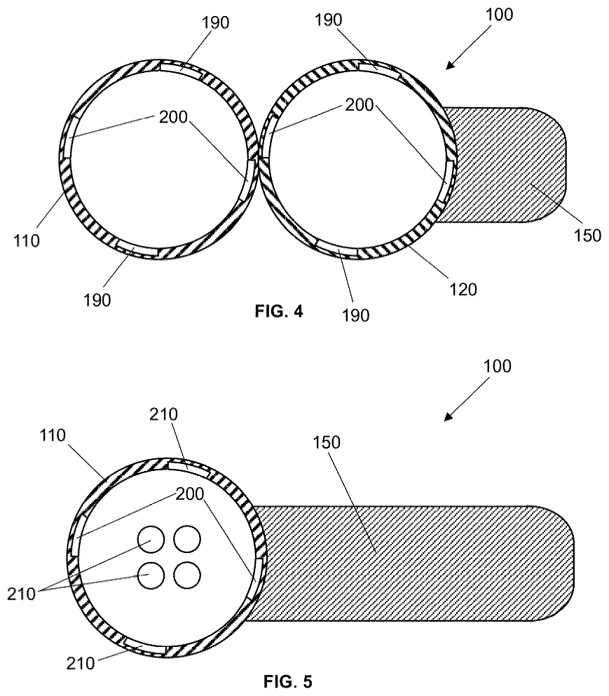

Referring to FIG. 4, a cross-sectional view taken along the first and second housings 110, 120 shows some internal structure thereof. First sensors 190 disposed within the first and second housings 110, 120 are operationally connected with the multifunctional circuitry 155 and the internal rechargeable power supply 145 both disposed within the body 150. In one embodiment, the first sensors 190 sense the type and level of e-liquid disposed within a reservoir portion 140 placed into each of the first and second housings 110, 120. The first sensors 190 detect a signal generated by a reservoir portion 140 upon being placed into either housing 110, 120. In one embodiment, the first sensors 190 detect a signal by making electrical contact with the reservoir portion 140. In another embodiment, the first sensors 190 detect a signal wirelessly, for example, each first sensor 190 is an RFID reader and each reservoir 140 includes an RFID tag readable by the RFID reader. In one embodiment, the first sensors 190 as illustrated in FIG. 4 span a small arc of the interior circumference of each of the first and second housings 110, 120. However, in other embodiments each first sensor 190 could span a larger arc, including for example, halfway around the interior circumference, more than halfway around the interior circumference, or entirely around the interior circumference.

Referring now to FIGS. 4 and 5, in one embodiment one or more magnets 200 are disposed on the interior surface and/or built integrally into each of the first and second housings 110, 120. For example, in one embodiment, the magnets 200 are disposed along an inside of the first housing 110 and/or the second housing 120. The magnets 200 provide a force to help secure the battery and reservoir portions 130, 140 within each of the housings, for example, to help secure the battery portion 130 and attached reservoir portion 140 within the first housing 110 and to help secure the reservoir portion 140 within the second housing 120.

The magnets 200 may also assist in placing the battery and reservoir portions 130, 140 into the housings 110, 120, respectively, by providing a motive force to pull the battery and reservoir portions 130, 140 into the respective housing 110, 120 and/or by providing a retentive force to resist the weight of the battery and reservoir portions 130, 140 that might otherwise cause them to inadvertently fall out of the housings 110, 120, respectively. For example, the material of a battery portion 130 and/or a reservoir portion 140 may be attracted to the magnets 200. In another embodiment, additional magnets may be included in the materials of the battery portion 130 and/or the reservoir portion 140, so that the poles of the magnets 200 within each of the housings 110, 120 align with the poles of the additional magnets of the battery portion 130 and/or the reservoir portion 140 to pull the battery portion 130 and/or the reservoir portion 140 into the respective housing 110, 120 and secure it there.

Referring to FIG. 5, second sensors 210, for example, electrical contacts 210, are disposed within the first housing 110 and operationally connected with the multifunctional circuitry 155 and the internal rechargeable power supply 145. In one exemplary embodiment, the second sensors 210 make contact with electrical contacts on the circumferential surface of the battery portion 130 when disposed within the first housing 110. In one embodiment, the second sensors 210 span a small arc of the interior circumference of the first housings 110. However, in other embodiments each second sensor 210 could span a larger arc, including for example, halfway around the interior circumference, more than halfway around the interior circumference, or entirely around the interior circumference. In another exemplary embodiment one or more second sensors 210 are disposed at an interior surface of a closed end of the first housing 110 and make contact with electrical contacts on an end surface of the battery portion 130 when disposed within the first housing 110. Although the second sensors 210 of the two exemplary embodiments are disposed at different positions within the first housing 110, both embodiments of the second sensors 210 have the same functions and are thus labeled with the same reference numeral 210.

Still referring to FIG. 5, in one embodiment the magnets 200 cooperate with the battery portion 130, for example, with a metallic or magnetic ring around the battery portion 130 to securely seat the battery portion 130 in contact with the second sensors 210 thus making an electrical connection with the multifunctional circuitry 155 via the second sensors 210. In one embodiment the multifunctional circuitry 155 determines the charge level of the battery portion 130 disposed within the first housing 110 via contact with the second sensors 210. In another embodiment, data stored within the reservoir portions 140 and/or the battery portion 130, for example, data regarding the charge level of the battery portion 130 and the type, levels, and usage of e-liquid in the reservoir portions 140 is collected by the multifunctional circuitry 155 via the sensors 210.

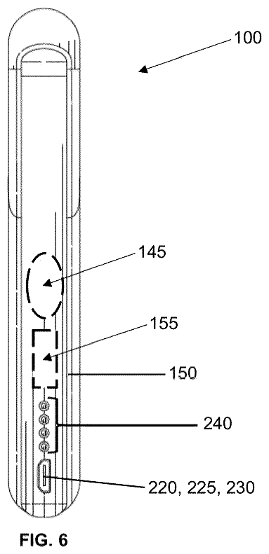

Referring to FIGS. 1 and 6, an interface 220 is disposed on the body 150 of the charging case 100. In one embodiment, the interface 220 is a power interface (labeled 225 to denote a power interface) that allows an external source of power to be supplied to recharge the internal rechargeable power supply 145. In one embodiment, the power interface 225 is a plugin type interface, for example without limitation, a USB type or a micro-USB type plugin interface as illustrated in FIG. 6. In another embodiment, the power interface 225 is an inductive charging interface (shown schematically as dashed triangle 225 in FIG. 1) that is built into the power supply 145 or that is part of the multifunctional circuitry 155. The inductive charging power interface 225 allows the power supply 145 to be wirelessly charged, for example, by being placed on a wireless charging pad.

In another embodiment, the interface 220 is a data interface (labeled 230 to denote a data interface). Data regarding the charge level of the battery portion 130 and the type, levels, and usage of e-liquid in the reservoir portions 140, for example, as collected by the first and second sensors 190, 210 is transmitted by the multifunctional circuitry 155 to the data interface 230. Data can also be transmitted to the multifunctional circuitry 155 from an external device via the data interface 230. In one embodiment, the data interface 230 is a plugin type interface, for example without limitation, a USB type or a micro-USB type plugin interface as illustrated in FIG. 6. In another embodiment, the data interface 230 is a wireless interface (shown schematically as dashed star 230 in FIG. 1) that is built into the multifunctional circuitry 155. The wireless data interface 230 allows the multifunctional circuitry 155 to wirelessly communicate with an external device.

Still referring to FIGS. 1 and 6, in yet another embodiment, the interface 220 is both a power interface 225 and a data interface 230. In this embodiment, the interface 220 has all the functionality as described for both of the above described embodiments of the power interface 225 and the data interface 230.

Referring now to FIG. 6, a third set of indicator lights 240 visible on an edge of the body 150 are controlled by the circuitry 155 to provide a user a visual indication of the state and/or activity of the charging case 100. In one embodiment, the indicator lights 240 illuminate in a first predetermined pattern of illumination that indicates that the data is being transmitted by the circuitry 155 to the data interface 230. The indicator lights 240 illuminate in a second predetermined pattern of illumination that indicates that the data is being transmitted to the circuitry 155 from the data interface 230. In another embodiment, the indicator lights 240 illuminate in a third predetermined pattern of illumination that indicates that power is being supplied to the internal rechargeable power supply 145 via the power interface 225. The predetermined patterns of illumination may comprise, for example, any combination of particular colors of illumination of each light, flashing of the lights in a particular sequence and/or at a particular frequency, or solid illumination of one or more of the lights.

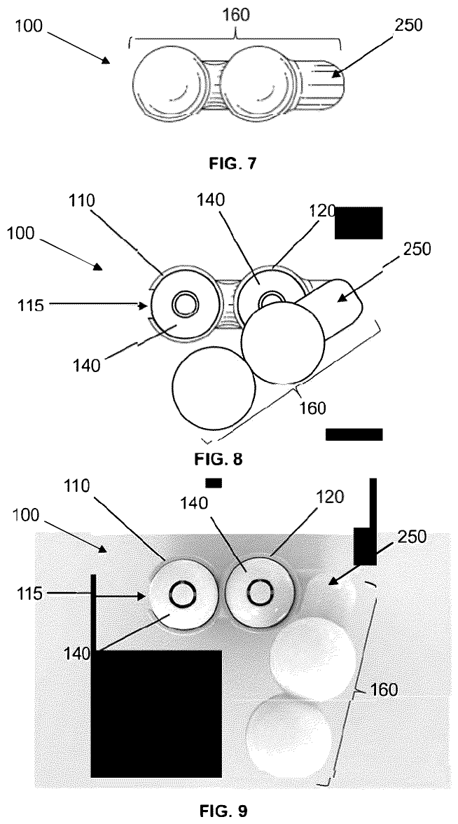

Referring to FIGS. 7-9, a closure 160 is mounted to an end of the charging case 100. The closure 160 can be positioned in a first closed position where open ends of the first and second housings 110, 120 are covered by the closure as shown in FIG. 7. The closure 160 can be positioned in a second partially closed position where an open end of the first housing 110 is uncovered by the closure 160 and an open end of the second housing 120 is at least partially covered by the closure 160 as shown in FIG. 8. The closure 160 can also be positioned in an open position where the open ends of the first and second housings 110, 120 are uncovered by the closure 160 as shown in FIG. 9.

Referring now also to FIG. 10, the closure 160 is mounted via a pivotal mechanism 250 to the charging case 100. In one embodiment, the pivoting mechanism 250 opens upwardly away from the body 150, for example, when a first internal bias is overcome. The pivoting mechanism 250 is also configured to limit rotation of the closure 160 relative to the first and second housings 110, 120, unless a second internal bias is overcome as further described below.

Referring to FIGS. 7-10, application of a first force downwardly applied on the closure 160 toward the charging case as indicated by arrow 260 in FIG. 10 and sufficient to overcome a first bias in the pivotal mechanism 250 releases the closure 160 to move away from the body 150 to a raised position shown in FIG. 10 where the closure 160 is clear of the top ends of the reservoir portions 140. Prior to any rotation of the closure mechanism 160 in the raised position, the closure 160 still covers the open ends of both of the first and second housings, as shown in FIG. 7. However, upon reaching the raised position the closure 160 is free to rotate as far as a first open position where an open end of the first housing 110 is uncovered by the closure 160 and an open end of the second housing 120 is at least partially covered by the closure 160, as shown in FIG. 8. In some embodiments, application of the first downwardly applied force results in an audible click as the first bias is overcome.

The closure 160 is prevented from rotating past the first open position shown in FIG. 8 unless another downward force is applied to the closure 160. Limiting rotation of the closure 160 in this way prevents the reservoir portion 140 in the second housing 120 from being removed from the charging case 100. Application of a second force downwardly applied on the closure 160 toward the charging case (again as indicated by arrow 260 in FIG. 10) and sufficient to overcome a second bias in the pivotal mechanism 250 releases the closure 160 to move beyond the first open position shown in FIG. 8 to a second open position where open ends of both of the first and second housings 110, 120 are uncovered by the closure 160 as shown in FIG. 9. In some embodiments, application of the second downwardly applied force results in an audible click as the second bias is overcome.

The closure 160 can be returned from an open or partially open position to a closed position covering both of the first and second housings 110, 120. From an open or partially open position the closure 16 is rotated until it is in a raised position above both of the first and second housings 110, 120. Upon reaching the raised position, the closure may be securely closed over the open ends of the first and second housings by applying force downwardly on the closure 160 in the direction indicated by the arrow 260 in FIG. 10. In some embodiments, returning the closure 160 to a closed position results in an audible click.

### INDUSTRIAL APPLICABILITY

The portable charging case provides space in two housings to carry a vaporization pen and a spare reservoir portion. An internal power supply charges a battery of the vaporization pen, and data regarding type and usage of e-liquid in the vaporization pen and the spare can be saved. Further the data can be transmitted from the portable charging case to another electronic device for analysis or presentation. The portable charging case requires a two-step procedure to fully open a closure that covers both housings. A first opening force is required to partially open the closure to access the housing holding the vaporization pen, and a second opening force is required to open the closure to further access the housing holding the spare reservoir portion.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

1. A system, comprising:
a vaporizer pen including a rechargeable battery;
a housing; and
at least one magnet disposed in one of the vaporizer pen or the housing, the at least one magnet configured to apply a retentive force between the vaporizer pen and the housing when the vaporizer pen is attached to the housing.

2. The system of claim 1, wherein the vaporizer pen further includes a sensor configured to detect a charge level of the rechargeable battery.

3. The system of claim 2, further comprising at least one light emitting diode (LED), the system configured to illuminate the at least one LED to indicate the charge level of the rechargeable battery.

4. The system of claim 1, further comprising at least one light emitting diode (LED), the system configured to illuminate the at least one LED to indicate that the vaporizer pen is being charged.

5. The system of claim 1, further comprising at least one light emitting diode (LED), the system configured to illuminate the at least one LED to indicate that data is being transmitted to circuitry of the vaporizer pen.

6. The system of claim 1, further comprising at least one light emitting diode (LED), the system configured to illuminate the at least one LED in a predetermined pattern.

7. The system of claim 6, wherein the predetermined pattern includes at least one of sequence of colors of illumination or a sequence of frequencies of illumination.

8. The system of claim 1, further comprising a Universal Serial Bus (USB) type interface that is electrically coupled to the rechargeable battery when the retentive force is applied between the vaporizer pen and the housing.

9. The system of claim 1, wherein at least one of the vaporizer pen or the housing includes medical grade plastic.

10. The system of claim 1, wherein the vaporizer pen further includes at least one reservoir portion.

11. A system, comprising:
a vaporizer pen including a battery;
a housing; and
at least one magnet disposed in one of the vaporizer pen or the housing, the at least one magnet configured to apply a force that pulls the vaporizer pen toward the housing and maintains physical contact between the vaporizer pen and the housing.

12. The system of claim 11, wherein the vaporizer pen further includes a sensor configured to detect a charge level of the battery.

13. The system of claim 12, further comprising at least one light emitting diode (LED), the system configured to illuminate the at least one LED to indicate the charge level of the battery.

14. The system of claim 11, further comprising at least one light emitting diode (LED), the system configured to illuminate the at least one LED to indicate that the vaporizer pen is being charged.

15. The system of claim 11, further comprising at least one light emitting diode (LED), the system configured to illuminate the at least one LED to indicate that data is being transmitted to circuitry of the vaporizer pen.

16. The system of claim 11, further comprising at least one light emitting diode (LED), the system configured to illuminate the at least one LED in a predetermined pattern.

17. The system of claim 16, wherein the predetermined pattern includes at least one of sequence of colors of illumination or a sequence of frequencies of illumination.

18. The system of claim 11, further comprising a Universal Serial Bus (USB) type interface that is electrically coupled to the rechargeable battery when the retentive force is applied between the vaporizer pen and the housing.

19. The system of claim 11, wherein at least one of the vaporizer pen or the housing includes medical grade plastic.

20. The system of claim 11, wherein the vaporizer pen further includes at least one reservoir portion.
